(19) United States
(12) Patent Application Publication
(10) Pub. No.: US 2017/0363796 A1
(43) Pub. Date: Dec. 21, 2017

(54) Backlight Module and Display Device

(71) Applicant: BOE Technology Group Co., Ltd., Beijing (CN)

(72) Inventors: Yongda Ma, Beijing (CN); Yuxin Zhang, Beijing (CN); Yong Qiao, Beijing (CN)

(73) Assignee: BOE Technology Group Co., Ltd., Beijing (CN)

(21) Appl. No.: 15/531,184

(22) PCT Filed: Nov. 10, 2016
(86) PCT No.: PCT/CN2016/105359

§ 371 Date: May 26, 2017

(30) Foreign Application Priority Data
Dec. 1, 2015 (CN) 201520976472.0

(51) Int. Cl. F21V 8/00

(52) U.S. Cl. CPC G02B 6/0043; G02B 6/0053

(57) ABSTRACT

Disclosed are a back light module including a light guide plate including a light exit surface and a dotted surface which is provided opposite to the light exit surface; and a first prism, providing on the light exit surface and having a length direction extending along a first direction. The dotted surface is provided with a plurality of first dot groups arranged along the first direction. Each of the first dot groups includes a plurality of dots, and a direction along which the dots of each of the first dot groups are arranged is perpendicular to the first direction. A display device is further disclosed.

### TECHNICAL FIELD

Embodiments of the present invention relates to a backlight module and a display device.

### BACKGROUND

A back light module is a light emitting structure fixed on a back of a liquid crystal display (simply referred as LCD). The back light module generally comprises a light source, a light guide plate, a light reflection sheet and a prism etc. The light guide plate is an important element of the back light module, and can covert a point light source or a line light source into a surface light source which is applicable to a display device.

Generally, the light guide plate comprises a light exit surface from which light emit. A dotted surface of the light guide plate opposite to the light exit surface is provided with a plurality of dots. Light emitting from the light source is diffused when the light incident on respective dots, and then it exits from the light exit surface which is parallel to the dotted surface. The dots with different density and different sizes are provided on different zones of the dotted surface of the light guide plate, so that the surface of the light guide plate emits light uniformly. The plurality of dots of the dotted surface are provided by methods of printing and etching etc.

The smaller the spacing between dots is (i.e. the dots are provided more intensively), the better the optical visual effects of the light guide plate are. In general, the dots are formed by processes such as printing and etching on the dotted surface. The spacing of the dots on the light guide plate cannot be decreased when the spacing is decreased to a certain distance, which results in poor optical visual effects of the light guide plate.

### SUMMARY

At least one embodiment of the disclosure provides a back light module comprising: a light guide plate comprising a light exit surface and a dotted surface which is provided opposite to the light exit surface; a first prism, providing on the light exit surface; wherein the dotted surface is provided with a plurality of first dot groups arranged along the first direction, each of the first dot groups comprises a plurality of dots, and the first direction is perpendicular to a direction along which the dots of each of the first dot groups are arranged; a length direction of the first prism is parallel to the first direction.

In an embodiment of the disclosure, the plurality of first dot groups arranged along the first direction are arranged in an array.

In an embodiment of the disclosure, the dots of each of the first dot groups are arranged linearly in equal space.

In an embodiment of the disclosure, the first direction is parallel to any of four sides of the light guide plate.

In an embodiment of the disclosure, an included angle of the first direction and any of four sides of the light guide plate is larger than 0 degree and smaller than 90 degrees.

In an embodiment of the disclosure, the back light module further comprises a second prism; the dotted surface is provided with a plurality of second dot groups arranged along the second direction, each of the second dot groups comprises a plurality of dots arranged in an array, and the second direction is perpendicular to a direction along which the dots of each of the second dot groups are arranged, and the second direction and the first direction intersect; a length direction of the second prism is parallel to the second direction; the light guide plate is formed integrally with the first and second prisms.

In an embodiment of the disclosure, the first prism is a prism film or a prism group comprising strip prisms parallel to each other.

In an embodiment of the disclosure, the light guide plate and the first prism is formed integrally.

At least one embodiment of the disclosure provides a display device comprising a display panel and the back light module of the first aspect.

In the back light module and the display device in the embodiments of the disclosure, a virtual image of a dot is formed on the dotted surface of the light guide plate by diffusing light through the dot and then refracting the light by the first prism, and a center of the virtual image of the dot does not overlap adjacent dots, and thus visual density of dots of the dotted surface is enhanced, so as to improve optical visual effects of the back light module.

### BRIEF DESCRIPTION OF THE DRAWINGS

In order to clearly illustrate the technical solution of the embodiments of the invention, the drawings of the embodiments will be briefly described in the following; it is obvious that the described drawings are only related to some embodiments of the invention and thus are not limitative of the invention.

FIG. 1 is a schematic diagram of a back light module according to an embodiment of the disclosure;

FIG. 2 is a schematic diagram of a dotted surface of a light guide plate according to an embodiment of the disclosure;

FIG. 3 is a schematic diagram of virtual images of dots according to an embodiment of the disclosure;

FIG. 4 is a schematic diagram of a dotted surface of the light guide plate according to an embodiment of the disclosure;

FIG. 5 is a schematic diagram of a back light module according to an embodiment of the disclosure; and

FIG. 6 is a schematic diagram of a dotted surface of the light guide plate according to an embodiment of the disclosure.

### DETAILED DESCRIPTION

In order to clearly illustrate the technical solution of the embodiments of the invention, the drawings of the embodiments will be briefly described in the following; it is obvious that the described drawings are only related to some embodiments of the invention and thus are not limitative of the invention.

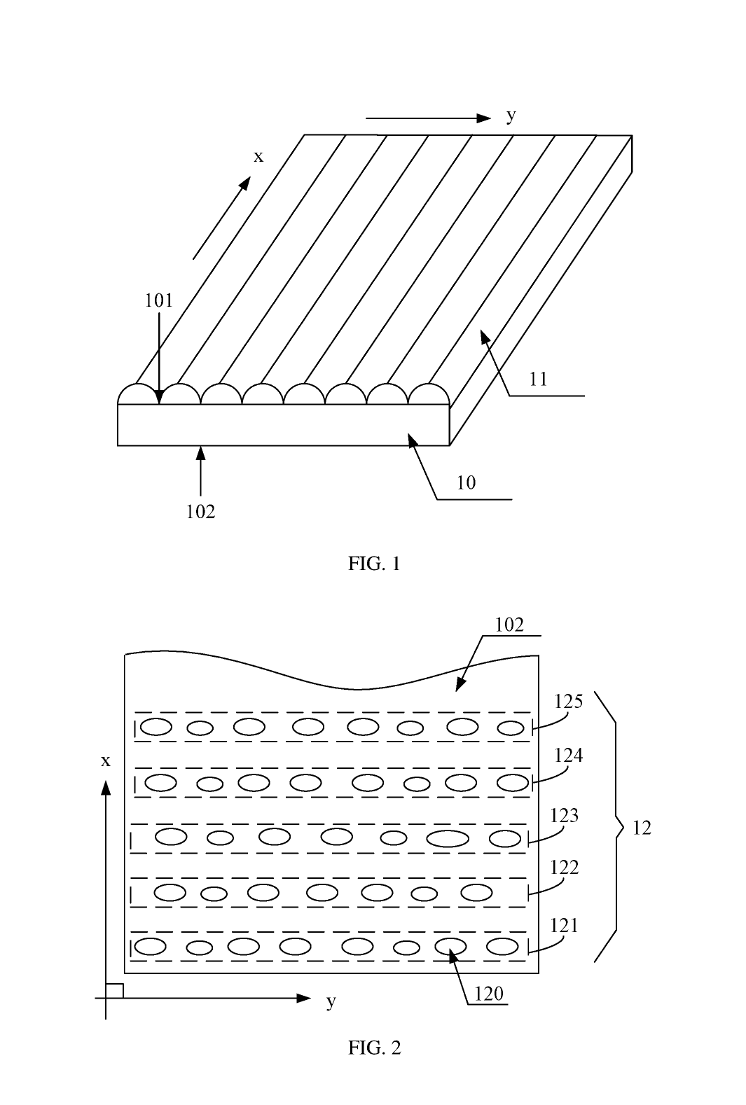

At least one embodiment of the disclosure provides a back light module, as illustrated in FIG. 1. The back light module comprises: a light guide plate 10, which comprises a light exit surface 101 and a dotted surface provided oppositely to the light exit surface; and a first prism 11, which is provided on the light exit surface 1. In the back light module as illustrated in FIG. 1, a length direction of the first prism 11 is parallel to a first direction x.

FIG. 2 is a schematic diagram of the dotted surface of the light guide plate according to an embodiment of the disclosure. As illustrated in FIG. 2, the dotted surface 102 of the light guide plate as illustrated in FIG. 1 is provided with a plurality of first dot groups 12, for example dot groups 121-125, which are arranged along the first direction x. The first direction x in FIG. 2 is the same as the first direction in FIG. 1. For example, the plurality of first dot group 12 arranged along the first direction x can be arranged in an array. Each of the first dot group 12 comprises a plurality of dots 120 arranged linearly. The first direction x is perpendicular to a direction y along which the dots 120 of each of the first dot groups 12 are arranged. As is shown, a length direction of the first prism 11 in FIG. 1 is parallel to the direction along which the first dot groups 12 are arranged, i.e., the first direction x.

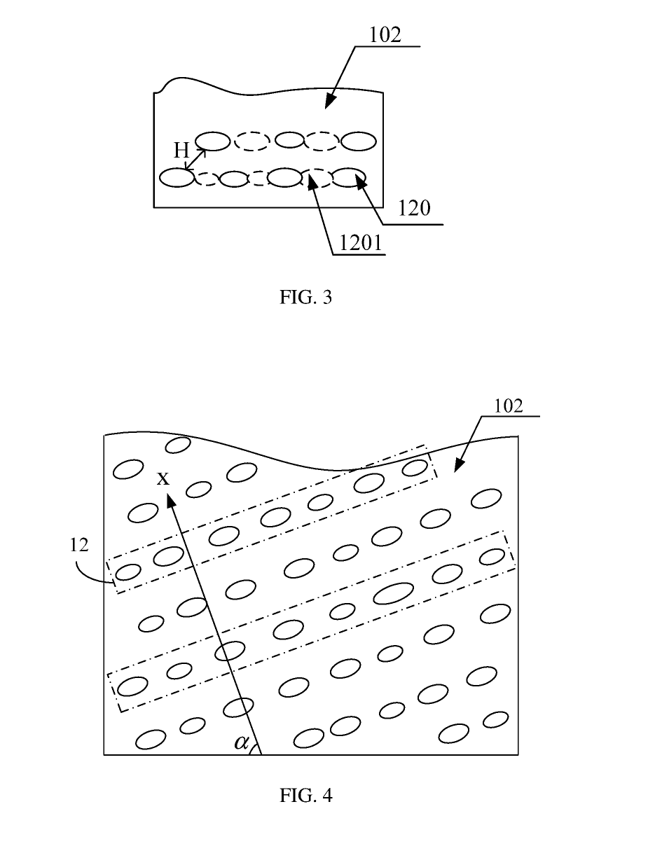

In the embodiment of the disclosure, because the length direction of the first prism 11 extends along the first direction x and is perpendicular to the direction y along which the dots of each of the dot groups are arranged, a virtual image of a dot is formed on the dotted surface of the light guide plate by diffusing light passing through the dot and refracting the light by the first prism 11. As illustrated in FIG. 3, a center of the virtual image 1201 of dot 120 formed by refracting of the prism does not overlap adjacent dots, so as to improve visual density of dots of the dotted surface.

In order to form a visual image of a dot on the dotted surface of the light guide plate by diffusing light through the dot and then refracting the light by the first prism, a projection of the first prism on the dotted surface is required to cover dots provided on the dotted surface.

At least one embodiment of the disclosure provides a back light module, The back light module comprises a light guide plate which comprises a light exit surface and a dotted surface provided oppositely to the light exit surface. The back light module further comprises a first prism, which is provided on the light exit surface of the light guide plate and which length direction extends along a first direction. The dotted surface of the light guide plate is provided with a plurality of first dot groups arranged along the first direction. Each of the first dot group comprises a plurality of dots arranged along a second direction. The first direction is perpendicular to the second direction. A virtual image of dots is formed on the dotted surface of the light guide plate by diffusing light through the dots and then refracting the light by the first prism, and a center of the virtual image of each dot does not overlap adjacent dots, and thus visual density of dots of the dotted surface is enhanced, so as to improve optical visual effects of the back light module.

In an embodiment of the disclosure, the plurality of the first groups can be arranged in an array along the first direction, for example, they are arranged in equal space along the first direction. Dots of each of the first dot groups are arranged linearly along the second direction, for example, they are arranged in equal space along the second direction.

In order to form a visual image of a dot on the dotted surface of the light guide plate by diffusing light through the dot and then refracting the light by the first prism, a projection of the first prism on the dotted surface is required to cover the dots provided on the dotted surface.

It should be noted that, if the minimum spacing constrained by manufacturing process of the dots is H, as illustrated in FIG. 3, a minimum spacing of two adjacent dots from two adjacent dot groups respectively can be set to the minimum spacing H, and a spacing between two adjacent dots from a same dot group can be larger than the minimum spacing H. The virtual image 1201 of the dot formed by refracting light by the prism is located between two adjacent dots from a same dot group, which enhances a visual density of dots of the dotted surface, so as to improve visual effects of the light guide plate.

In an embodiment of the disclosure, as illustrated in FIG. 2, the first direction x along which the first dot groups 12 are arranged can be parallel to any of four sides of the light guide plate. In this case, the length direction of the first prism 11 is parallel to any of four sides of the light guide plate.

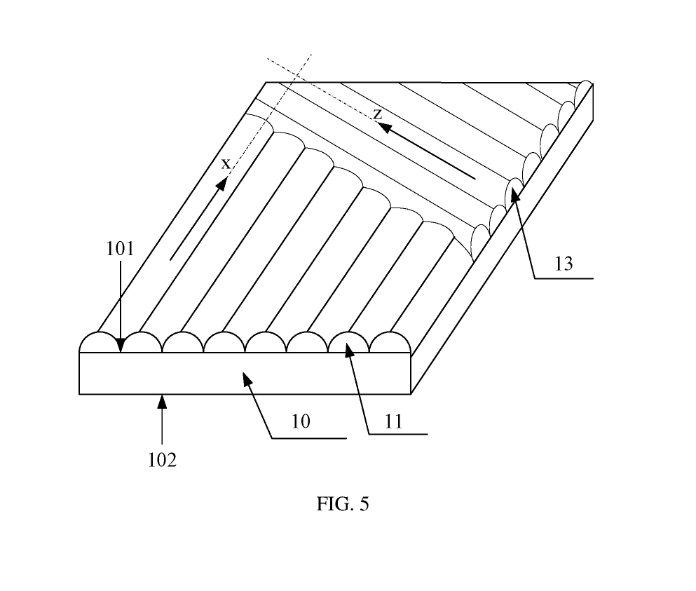

FIG. 4 is a schematic diagram of the dotted surface of the light guide plate according to another embodiment of the disclosure. As illustrated in FIG. 4, an angle of the first direction x along which the first dot groups 12 are arranged and any one of four sides of the light guide plate can be α which is larger than 0 degree and smaller than 90 degrees. In this case, an angle of the length direction of the first prism 11 and the any one of four sides of the light guide plate is α as well, to ensure that the length direction of the first prism 11 is parallel to the first direction x.

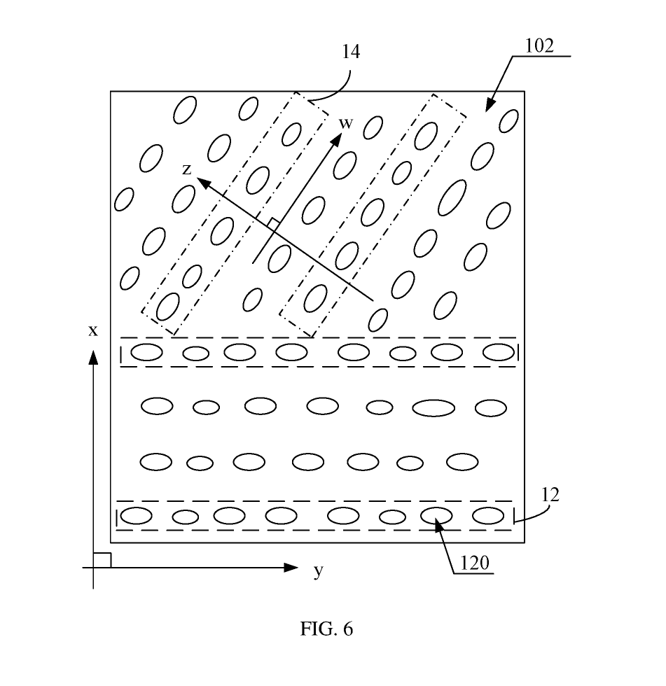

FIG. 5 is a schematic diagram of the back light module according to another embodiment of the disclosure. As illustrated in FIG. 5, the back light module can further comprise a second prism 12. That is, the light exit surface 101 of the light guide plate is provided with the first prism 11 and the second prism 13 at the same time, and length directions of the first prism 11 and the second prism 13 are not parallel. In this case, dots of the dotted surface 102 of the light guide plate can be provided as illustrated in FIG. 6. The dotted surface 102 can further be provided with a plurality of second dot groups 14 arranged in an array along a second direction z. Each of the second dot groups 14 can comprise a plurality of dots arranged linearly. The second direction z is perpendicular to a direction w along which the dots of each of the second dot groups 14 are arranged, and the second direction z and the first direction x intersect. The length direction of the second prism 13 in FIG. 5 is parallel to a direction, i.e. the second direction z, along which the second dot groups 14 are arranged in FIG. 6. Because two groups of prisms with different length directions are provided on the light exit surface of the light guide plate, the light guide plate 10 can be formed integrally with the first prism 11 and the second prism 12, in order to ensure visual effects of the back light module.

It should be noted that, the first direction x in FIG. 5 and the first direction x in FIG. 6 are the same direction, and the second direction z in FIG. 5 and the second direction z in FIG. 6 are the same direction.

In order to form a visual image of a dot of the second dot groups on the dotted surface of the light guide plate by diffusing light through the dot and then refracting the light by the second prism, a projection of the second prism on the dotted surface is required to cover dots of the second dot groups provided on the dotted surface.

In an embodiment of the disclosure, the first prism 11 can be prism film or a prism group comprising strip prisms parallel to each other. The light guide plate 10 and the first prism 11 can be formed integrally. The light guide plate and the first prism is formed integrally, which can not only improve assembly efficiency of the back light module, but also reduce a thickness of the back light module.

At least one embodiment of the disclosure provides a back light module which comprises a light guide plate. The light guide plate comprises a light exit surface and a dotted surface provided oppositely to the light exit surface. The back light module further comprises a first prism, which is provided on the light exit surface of the light guide plate and which length direction extends along a first direction. The dotted surface of the light guide plate is provided with a plurality of first dot groups arranged along the first direction. Each of the first dot groups comprises a plurality of dots. The first direction is perpendicular to a direction along which dots of each of the first dot groups are arranged. Thus, a virtual image of a dot is formed on the dotted surface of the light guide plate by diffusing light through the dot and then refracting the light by the first prism, and a center of the virtual image of each dot does not overlap adjacent dots, and thus visual density of dots of the dotted surface is enhanced, so as to improve optical visual effects of the back light module.

In order to form a visual image of a dot on the dotted surface of the light guide plate by diffusing light through the dot and then refracting the light by the first prism, a projection of the first prism on the dotted surface is required to cover dots provided on the dotted surface.

In an embodiment of the disclosure, the plurality of the first dot groups can be arranged in an array along the first direction, for example, they are arranged in equal space along the first direction.

Dots of each of the first dot groups are arranged linearly along the second direction, for example, they are arranged in equal space along the second direction.

When the back light module provided by embodiments of the disclosure is manufactured and assembled in some examples, the light guide plate is firstly manufactured, and then a plurality of dot groups arranged in an array along a first direction are provided on a side of the light guide plate by a printing manner (if the dots are provided by a non-printing manner, for example, a manner of etching or mechanical cutting, dots which are designed in advance can be casted on a mold, so that the dots can be formed on the dotted surface directly when the light guide plate is formed). After that, the prism can be provided on the light exit surface of the light guide plate, and the length direction of the prism and the first direction are ensured to be parallel. If the light guide plate and the prism is formed integrally, the prism has been provided when the light guide plate is formed.

At least one embodiment of the disclosure provides a display device. The display device comprises a display panel and a back light module illustrated in any one of FIGS. 1-6.

What are described above is related to the illustrative embodiments of the disclosure only and not limitative to the scope of the disclosure; the scopes of the disclosure are defined by the accompanying claims.

The application claims priority to the Chinese patent application No. 201520976472.0, filed Dec. 1, 2015, the entire disclosure of which is incorporated herein by reference as part of the present application.

1. A back light module, comprising:
a light guide plate comprising a light exit surface and a dotted surface which is provided opposite to the light exit surface; and
a first prism, providing on the light exit surface and having a length direction extending along a first direction;
wherein the dotted surface is provided with a plurality of first dot groups arranged along the first direction, each of the first dot groups comprises a plurality of dots, and the first direction is perpendicular to a direction along which the dots of each of the first dot groups are arranged.

2. The back light module of claim 1, wherein the plurality of first dot groups arranged along the first direction are arranged in an array.

3. The back light module of claim 1, wherein the dots of each of the first dot groups are arranged in equal space.

4. The back light module of claim 1, wherein a projection of the first prism on the dotted surface covers the dots of the first dot groups.

5. The back light module of claim 1, wherein the first direction is parallel to any of four sides of the light guide plate.

6. The back light module of claim 1, wherein an angle between the first direction and any of four sides of the light guide plate is larger than 0 degree and smaller than 90 degrees.

7. The back light module of claim 1, further comprising:
a second prism, providing on the light exit surface and having a length direction extending along a second direction,
wherein the dotted surface is provided with a plurality of second dot groups arranged along the second direction, each of the second dot groups comprises a plurality of dots, and the second direction is perpendicular to a direction along which the dots of each of the second dot groups are arranged, and the second direction and the first direction intersect;
the light guide plate is formed integrally with the first and second prisms.

8. The back light module of claim 7, wherein the plurality of second dot groups arranged along the second direction are arranged in an array.

9. The back light module of claim 7, wherein the dots of each of the second dot groups are arranged in equal space.

10. The back light module of claim 7, wherein a projection of the second prism on the dotted surface covers the dots of the second dot groups.

11. The back light module of claim 1, wherein the first prism is a prism film or a prism group comprising strip prisms parallel to each other.

12. The back light module of claim 1, wherein the light guide plate and the first prism is formed integrally.

13. The back light module of claim 1, wherein the second prism is a prism film or a prism group comprising strip prisms parallel to each other.

14. A display device, comprising: a display panel and the back light module of claim 1.

15. The display device of claim 14, wherein the plurality of first dot groups arranged along the first direction are arranged in an array.

16. The display device of claim 14, wherein the dots of each of the first dot groups are arranged in equal space.

17. The display device of claim 14, wherein a projection of the first prism on the dotted surface covers the dots of the first dot groups.

18. The display device of claim 14, wherein the first direction is parallel to any of four sides of the light guide plate.

19. The display device of claim 14, wherein an angle between the first direction and any of four sides of the light guide plate is larger than 0 degree and smaller than 90 degrees.

20. The display device of claim 14, further comprising:
a second prism, providing on the light exit surface and having a length direction extending along a second direction,
wherein the dotted surface is provided with a plurality of second dot groups arranged along the second direction, each of the second dot groups comprises a plurality of dots, and the second direction is perpendicular to a direction along which the dots of each of the second dot groups are arranged, and the second direction and the first direction intersect;
the light guide plate is formed integrally with the first and second prisms.
